(19) United States
(12) Patent Application Publication
(10) Pub. No.: US 2015/0205831 A1
(43) Pub. Date: Jul. 23, 2015

(54) END-TO-END DATA PROVENANCE

(71) Applicants: Robert Rundle, Albuquerque, NM (US); Nicolaas Pleun Bax, Hendrik Ido Ambacht (NL)

(72) Inventors: Robert Rundle, Albuquerque, NM (US); Nicolaas Pleun Bax, Hendrik Ido Ambacht (NL)

(73) Assignee: BAKER HUGHES INCORPORATED, Houston, TX (US)

(21) Appl. No.: 14/595,781

(22) Filed: Jan. 13, 2015

Related U.S. Application Data
(60) Provisional application No. 61/927,069, filed on Jan. 14, 2014.

(51) Int. Cl. G06F 17/30

(52) U.S. Cl. CPC G06F 17/30386; G06F 17/30309

(57) ABSTRACT

An embodiment of a computer-readable storage medium is provided for performing a method of storing a data object. The method includes: storing a globally unique object identifier that identifies the object, the object representing a data set; storing a globally unique version identifier for each version of the object created by performing an action on the object, each version identifier stored in a version table associated with the object; generating a globally unique action identifier in response to the action performed on the object, the action selected from at least one of creation of the object and modification of the object; and storing an action table associated with the object and having a relation to the version table, the action table including a description of the action, the action table configured to store a record of all actions performed on the object and allow inspection of all actions.

### CROSS-REFERENCE TO RELATED APPLICATION

This application claims the benefit of an earlier filing date from U.S. Provisional Application Ser. No. 61/927,069 filed Jan. 14, 2014, the entire disclosure of which is incorporated herein by reference.

### BACKGROUND

Various processing tools are utilized in relation to energy industry operations and are used to perform tasks including data collection, storage, modelling and analysis. Data from various sources (e.g., measurement and analysis data from various well locations and regions) can be aggregated in a repository for access by numerous users. Object-oriented programming is used to manage data sets, and involves the interaction among a plurality of data objects to implement a computer application.

Some data collection systems are configured as a distributed object system, which includes multiple nodes, each of which is capable of storing a variable amount of object data. Distributed objects may be spread over multiple computers in the system or multiple processors within a computer, and different objects may be managed by different users on different systems. Such distributed object systems might include a large number of nodes which are remotely located relative to one another and connected together in opportunistic ways.

In some instances, errors are introduced into objects over the course of one or more modifications to the object. Such errors typically are not evident from simple inspection of the object. In order to determine whether such errors have been introduced to the object, an understanding of all modifications made to the object over the course of its life is needed.

### SUMMARY

An embodiment of a non-transitory computer-readable storage medium stores instructions which, when processed by a processor, cause the processor to implement a method of storing a data object and object provenance. The method includes: storing a globally unique object identifier that identifies the object, the object representing a data set; storing a globally unique version identifier for each version of the object created by performing an action on the object, each version identifier stored in a version table associated with the object; generating a globally unique action identifier in response to the action performed on the object, the action selected from at least one of creation of the object and modification of the object; and storing an action table associated with the object and having a relation to the version table, the action table including a description of the action, the action table configured to store a record of all actions performed on the object and allow inspection of all actions.

An embodiment of a method of storing a data object and object provenance includes: storing a globally unique object identifier that identifies the object, the object representing a data set; storing a globally unique version identifier for each version of the object created by performing an action on the object, each version identifier stored in a version table associated with the object; generating a globally unique action identifier in response to the action performed on the object, the action selected from at least one of creation of the object and modification of the object; and storing an action table associated with the object and having a relation to the version table, the action table including a description of the action, the action table configured to store a record of all actions performed on the object and allow inspection of all actions.

### BRIEF DESCRIPTION OF THE DRAWINGS

Referring now to the drawings wherein like elements are numbered alike in the several Figures:

FIG. 1 is a block diagram of an embodiment of a distributed data storage, processing and communication system;

FIG. 2 illustrates identifiers and metadata associated with a data object stored in the system of FIG. 1;

FIG. 3 illustrates an architecture for a multi-user data storage system; and

FIG. 4 is a diagram illustrating an embodiment of a data model for storing and organizing identifiers and metadata associated with data objects, and for tracking actions performed on the data objects by one or more users; and

FIG. 5 illustrates exemplary relationships between versions of a data object.

### DETAILED DESCRIPTION

Apparatuses, systems, methods and computer program products are provided for collection, storage and transmission of data. An exemplary apparatus includes a computer program product for execution of a software program that manages data as objects stored in a distributed network. Each object stored in the network includes metadata and actual data. The program can be configured to manage any data distributed over a network to which multiple writers have access. For example, the data may be oil and gas or energy industry data, but is not limited thereto.

Embodiments described herein include features that allow for establishing end-to-end data provenance for each object or other data structure stored in a computing and/or storage system. Data provenance is the chronology of an object, i.e., all of the transformations and actions that modified the state of the object from the time of creation to the present time. End-to-end data provenance is the ability to account not only for the data provenance of a single object, but also to account recursively for the data provenance of all other objects that affected the state of the object.

A system includes various features that implement end-to-end data provenance. Unique identifiers are associated with an object that uniquely identify the object and the object version. An audit trail is connected to the object and details each object modification. In one embodiment, the audit trail is a list of actions (e.g., one for each version of the object) that have been performed on the object. The audit trail, in one embodiment, includes a unique action identifier, an action description, and a user identifier for each action performed on the object. The audit trail is bound to the object, e.g., as an Action table including a unique identifier for each action that is related to each version of the object.

While embodiments are detailed below with specific reference to distributed objects for explanatory purposes, alternate embodiments apply, as well, to other multi-version environments.

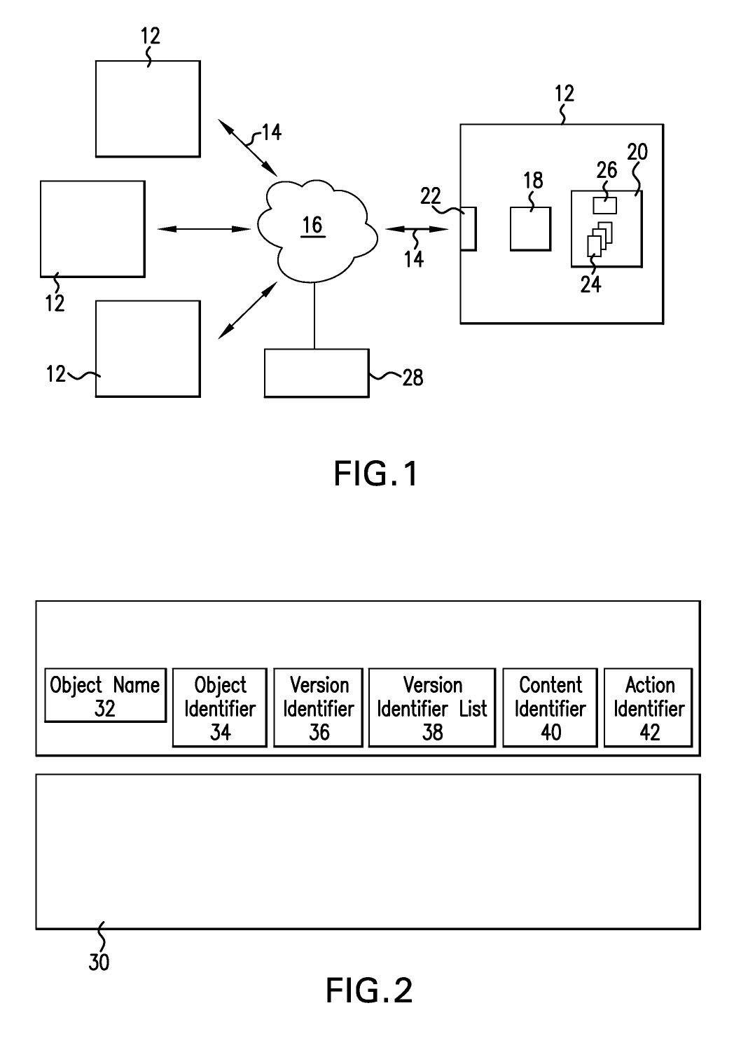

FIG. 1 is a block diagram of a distributed data storage, processing and communication system 10. The system 10 includes a plurality of processing devices or nodes 12. The nodes 12 each have computing components and capabilities, are connected by links 14, which may be wired or wireless. One or more of the nodes 12 may be connected via a network 16, such as the internet or an internal network. Each node 12 is capable of independent processing, and includes suitable components such as a processor 18, memory 20 and input/output interface(s) 22. The memory 20 stores data objects 24 or other data structures, and a program or program suite 26. The nodes may be computing devices of varying size and capabilities such as server machines, desktop computers, laptops, tablets and other mobile devices.

An exemplary program is an energy industry data storage, analysis and/or modeling software program. An example is JewelSuite™ analysis and modeling software by Baker Hughes Incorporated.

In one embodiment, the system includes one or more data storage locations. For example, the system 10 includes a centralized data repository 28. The repository 28 is accessible by each node 12. In one embodiment, the system 10 includes a Distributed Object Network, where each node 12 can access and be used to edit a distributed object, e.g., an object 24. Thus, users can independently retrieve copy and edit stored data. This independent editing may result in numerous different versions or copies of an object. As described herein, a “user” refers to a human or processing device capable of accessing and interacting with objects and/or data.

An object is a container for state information and also defines methods and properties that act on that state. An object type is a template that can be used to create an unlimited number of objects, which are initially identical, but become different as the object state changes.

In a distributed object system, some objects are transitory, derivative of other objects, or are otherwise of secondary importance to this discussion. Exemplary objects of interest are objects that map to real world objects, both physical and abstract, and together model the domain of interest. These objects are designated as domain objects. Objects may include any type of data for which storage and access is desired. For example, embodiments described herein are described in the context of energy industry or oil and gas data, but are not so limited.

Energy industry data includes any data or information collected during performance of an energy industry operation, such as surface or subsurface measurement and modeling, reservoir characterization and modeling, formation evaluation (e.g., pore pressure, lithology, fracture identification, etc.), stimulation (e.g., hydraulic fracturing, acid stimulation), drilling, completion and production. Exemplary domain objects in the oil and gas domain include fields, reservoirs, wells, geological grids, faults, horizons, and fluid contacts.

Examples of domain objects include wells and simulation grids. An example of an object that is not a domain object because of abstraction is a 3D view object that controls the view of an object, such as a subterranean reservoir data object. The state of the 3D view is serialized to an object file so that when the object file is reopened, the view of the reservoir is restored to the same viewing angle and zoom level. However the state of the 3D view object is irrelevant to the real world problem that is being analyzed, and thus this object is not considered a domain object. An example of an object that is not a domain object because of derivation is a well graphics object. The well graphics object implements rendering of a well domain object on the 3D view. The well graphics object contains no state of its own but accesses the state of the well domain object.

In a distributed object system, metadata provides a concise description of the object that can be distributed broadly while the actual data represents the complete object that is often very large and time consuming to move. The metadata is used to identify and/or provide information regarding an object, such as the object type, version, and parameters that the data in the object represents.

An Object Identifier (“Oid”) is the globally unique identifier that is used to set each object or domain object apart. When an object or domain object of a particular type is created, a new Oid is generated for it. The Oid may be any suitable type of identifier. An exemplary identifier is a lightweight identifier such as a universally unique identifier (UUID) as specified in RFC 4122.

A Version Identifier (“Vid”) is the globally unique identifier that is used to set each version of an object or domain object apart. When an object or domain object of a particular type is created, a new Vid is generated for it, representing the initial, default state of the domain object. As each new version of the domain object is created as a result of self-consistent changes to the state, a new Vid is generated. An exemplary identifier is a lightweight identifier such as a universally unique identifier (UUID) as specified in RFC 4122.

Exemplary metadata that is associated with an object 30 is shown in FIG. 2. Such metadata is described as associated with a domain object, but may also be associated with any object or other data structure. Each object 30 may be imprecisely identified by a tuple (Name, Version Number), where “Name” is the object name 32, which may not be unique to the particular domain object 30, and “Version Number” may also not be unique to the domain object 30. Each object 30 may also be precisely identified by a tuple (Oid, Vid), where Oid 34 is an object identifier and Vid 36 is a version identifier. Each of the identifiers (Oid 34 and Vid 36) is universally unique such that, regardless of which user or processing device is editing an object 30, unrelated objects 30 will not have the same Oid 34 and two different edits of the same object 30 will not have the same Vid 36. All objects 30 resulting from the same initial object 30 will have the same Oid 34. However, when one object 30 stems from another, the two objects 30 will have a different Vid 36. Thus, the tuple (Oid, Vid) is unique for each non-identical object 30. The metadata may also include a list of all Vid 36 associated with that object 30, shown in FIG. 2 as a Version identifier List or “VidList” 38. This allows any two object identifiers to be compared to determine the object kinship (e.g., unrelated, identical, ancestor, descendant, or cousin). The metadata may also include a Parent Version Identifier (“ParentVid”), which connects or relates the VidList 38 to each version and associated Vid 36. The ParentVid indicates the previous version of a particular version of an object, i.e., the version of the object that was edited or otherwise use to create the particular version.

Identification of object kinship can be achieved using a baseline, which is a snapshot or reference list of objects at a given time. Each user and/or processing device may maintain a baseline, and, when a user runs the program generated with the distributed objects, baselines are merged and reconciled. The baseline and object identification process is described in U.S. Publication No. 2014/0351213, published Nov. 27, 2014 (application Ser. No. 13/898,762 filed May 21, 2013), the contents of which are incorporated herein by reference in its entirety.

As described herein, “metadata” may refer to all data structures associated with an object that are not the data set (referred to as “actual data”) that is stored as the object. For example, metadata may refer to the object name, identifier, version identifier and the version identifier list. In other example, metadata may be described separate from the object identifier, such that a representation of an object can include the object identifier, metadata and/or the actual data. The object identifier and/or the metadata can thus be accessed, transmitted and stored independent of the data set while maintaining a relation to the data set.

For each node of the distributed object system, a mechanism is provided to organize the metadata for all objects represented on that node. An exemplary mechanism includes an entity-attribute-value (EAV) organizational scheme. A data model for the metadata includes related tables or other data structure for object identification, parameter or attribute identification, and for parameter values. This scheme can be used for energy industry data or any other kind of data.

In one embodiment, the metadata is loosely coupled to the actual data for an object. “Loose” coupling refers to establishment of a relation between the metadata and the actual data so that metadata can be separately managed and transmitted between nodes while remaining tied to the actual data. This loose coupling is enabled between metadata and actual data and accurately maintained even in the event of changes to either metadata or actual data from multiple sources. The actual data for an object can be stored within the distributed object system and coupled to the metadata such that each can be replicated, synchronized and otherwise moved through the nodes of the distributed object system independent of each other.

Referring again to FIG. 2, the metadata may include a content identifier 40 that is related to the object identifier 34 and the version identifier 36. The content identifier provides a mechanism to loosely couple the metadata to actual data, allowing the metadata to be distributed separately from the actual data while still tying the metadata to the actual data so that a user can identify the object and all versions of the object. For example, the content identifier 40 is written in a content table or other structure that stores the actual data, and is related to a version table that includes the version identifier 36 and the content identifier 40. Thus, in the system, the object 30 can be represented on each node in one of three ways: as an object identifier, as an object identifier with metadata, or as a complete object including identifier, metadata and actual data.

The Content Identifier (“Cid”) is a globally unique identifier that is used to identify actual content of a specific version of an object. This content might be stored in a variety of values. It might be stored as a binary large object (BLOB) in a data base or a file on disk. The content might be stored in a contiguous manner or broken into fragments that are stored separately. The Cid refers to the object actual content as a whole. Moreover the Cid represents a specific and unique location for the object content. If the object content is replicated the new copy of the object content is assigned a new Cid.

In one embodiment, a data provenance record is stored and associated with each object, to provide a record of all actions performed on the object. An “action” is any operation performed on an object, and includes initial creation of the object and any operation (e.g., modification and/or addition of data to the object) that results in storage of a new version of the object.

Provenance of a data object (or other data structure) is the history or chronology of an object, and is important for establishing the value of a data set or object. The value of a set of data or object in many cases cannot be made by simply inspecting it. The fact that the data set is self-consistent is not good enough in some cases. The data provenance record described herein facilitates the determination of whether errors have been introduced or whether the data has been corrupted in some way, and provides a complete understanding of the precursor forms of the data and all inputs. All forms of data input are subject to certain types of error, and the ability to establish to some degree of precision the effect of this error on the resulting data set greatly enhances its value and applicability.

The data provenance embodiments described herein include indications and/or descriptions of all of the transformations and actions that modified the state of an object from the time of creation to the present time. In one embodiment, the embodiments establish end-to-end data provenance, which accounts not only for the data provenance of a single object, but also accounts recursively for the data provenance of all other objects that affected the state of the object.

Embodiments described herein provide a system to implement end-to-end data provenance. This system has several aspects: (1) the ability to uniquely identify the object version, (2) the ability to maintain an audit trail (i.e., a record of actions) that details each object modification, and (3) the binding of the audit trail to the object.

FIG. 2 shows an embodiment of an action identifier (“Aid”) 42, which uniquely identifies an action performed on an object or domain object. The action identifier 42 is a globally unique identifier that is assigned to each version of an object and sets each version apart from other versions. The Aid may be any type of unique identifier, for example, a lightweight identifier such as a universally unique identifier (UUID) as specified in RFC 4122. The action identifier 42 is related or associated with a specific version of the object, e.g., related to the version identifier 36. Although the action identifier 42 is shown as part of the metadata for an object 30 it is not so limited, and may be stored in any suitable location.

In one embodiment, a different action identifier is created for each action and associated version of an object, and all action identifiers associated with a particular object is stored in a common data structure. For example, each action identifier 42 is stored in an action table that is related to a version table including the version identifier 36. In one embodiment, the action table (or other data structure) includes the action identifier (Aid), a description of the action, an identification of the user that performed the action (a “user identifier”), and/or the data and time of implementation of the action.

The action table or other structure thus includes a list of all of the actions performed on an object. This list is referred to herein as an “audit trail”. The audit trail can be applied to any data object or other data storage structure. In addition, the audit trail may be configured to track actions on multiple objects in a project or other object group, and may be configured to track actions performed by multiple users.

In one embodiment, the audit trail for a domain object or other object is the list of actions that modified the state of the object, starting with the action that created the object. There is one action for each version of the object.

The audit trails for a group of objects in a system or container can be related and tracked using a baseline. The baseline can be associated with any number of objects. Thus, an aggregate list of audit trails for all objects in a group (e.g., within a container or in a storage device or network) can be created, which is referred to herein as a “baseline audit trail.”

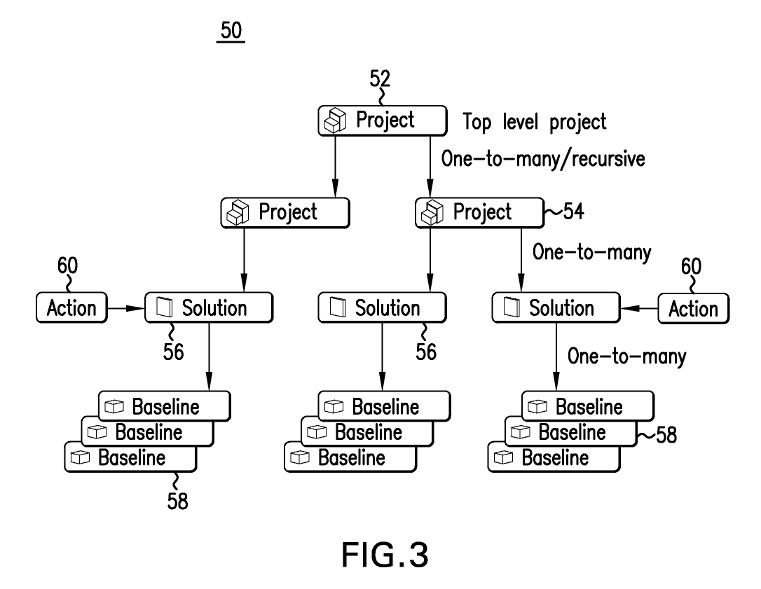

FIG. 3 shows an exemplary architecture 50 that illustrates the interaction between the audit trail(s) and action table(s) for an object or group of objects and the baseline(s) associated with an object or group of objects. As shown in FIG. 3, multiple objects can be stored or grouped together in various ways.

FIG. 3 includes examples of baseline containers, shown as a top level project container 52, lower level project containers 54 and solution containers 56. Each baseline container is a data construction in which a collection of baselines resides. The baseline container forms a boundary around one or more baselines. In one embodiment, every baseline must exist within a baseline container. Containers can be nested but do not overlap.

The baseline containers can be given names that are meaningful to users, such as “project” and “solution”. These examples are useful for containers that include baselines that reference objects related to energy industry operations and data.

In the example of FIG. 3, the top level project container 52 is a parent of one or more individual project containers 54, each of which is a parent of one or more solution containers 56. Each solution container 56 may be in any suitable form (e.g., a table) and stored in a suitable format, such as a disk file, that contains a complete and self-consistent set of one or more baselines that can be opened with the software.

Each baseline 58 is a subgrouping of objects that have the characteristic of being self-consistent at a specific time, the time when the baseline was created.

As shown above, a domain object or baseline container (e.g., project or solution container) is not a baseline. An object can be part of many baselines which can overlap in various ways. A baseline can be a member of only one baseline container. The domain objects to which a baseline refers are not constrained by any container and may be considered part of the general population of domain objects that comprise the distributed object system. While it is common to say that an object is in a container, in precise terms this means that the container contains a baseline which has a reference to the object.

Each object or container is associated with an action table 60 that stores an action identifier, description, user identifier and other suitable information for each version of an object in a container, e.g., a solution container 56. The action table may store actions for a single object, or store actions for multiple objects referenced by baselines in a container. Thus, each solution container 56 may be related to a single action table 60 that stores all actions for all objects (and versions thereof) in the container. In addition, the action table 60 identifies the user that performed each action. A user can easily inspect the provenance of a single object and/or inspect the provenance of all objects in the container (end-to-end provenance).

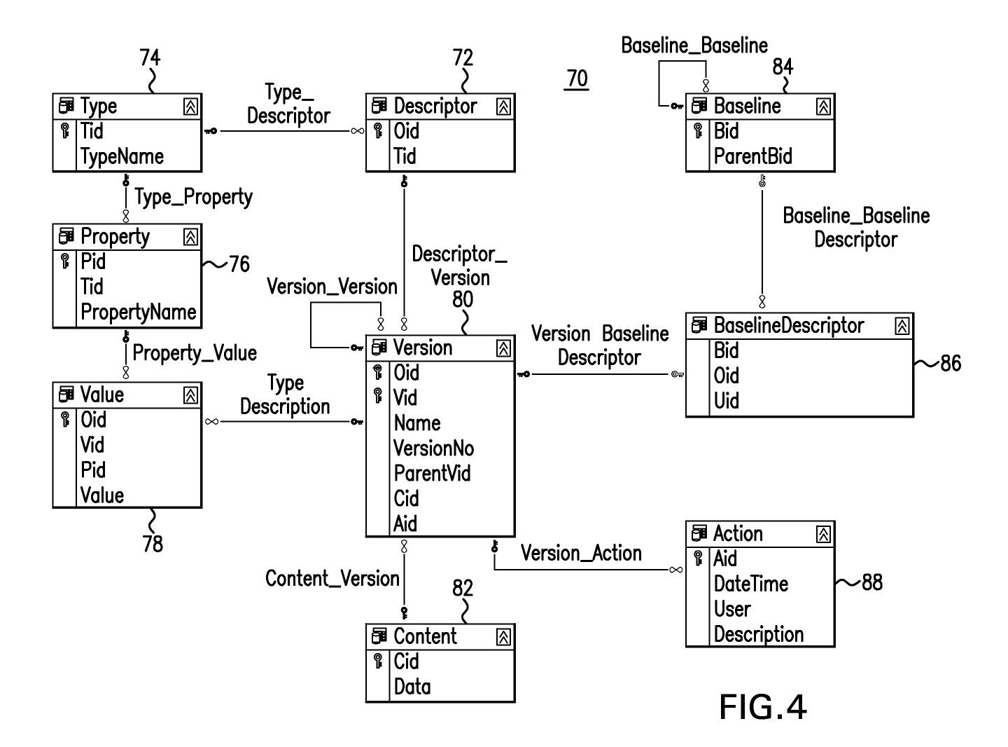

FIG. 4 shows an example of an organization scheme for metadata. A data model is shown that provides for data provenance for an object and/or a group of objects. The data model includes various tables that store information regarding one or more objects in, e.g., a solution or project container. It is noted that the data provenance features described herein are not limited to the metadata configuration shown in FIG. 4. Any suitable organization may be employed that provides a relation between object versions and action tables or other data structures. For example, the data model can employ an organization scheme other than an entity-attribute-value (“EAV”) approach (described further below), and need not be used in conjunction with baselines. Thus, in one example, the metadata includes object description data, version data and an action table related to the version data, and may optionally include additional tables and data structures as described further below.

Each block in the diagram shown in FIG. 4 represents a relational table, which may be stored in a database or repository and accessible by a node. Each entry in the block represents a column in the table.

FIG. 4 shows a relational schema that implements an EAV data model. A descriptor table 72 (the “entity” of the EAV model) includes an Oid column for storing the unique identifier for an object and a Type identifier (“Tid”) column for storing an indication of the object type. A type table 74 includes the Tid and a Type Name column. A Property or parameter table 76 (the “attribute” of the EAV model) includes a Property identifier (“Pid”) column, a Tid column and a Property Name column. A Value table 78 includes an Oid column, a Value identifier (“Vid”) column for storing the Vid, a Pid column and a Value column for storing the actual property value. A Version table 80 includes Oid, Vid, Name, Version number, ParentVid, Cid and/or Aid columns.

The lines between blocks represent one-to-many relations between the rows of one table and the rows of another table. The relations are from parent to child table. A key symbol designates the parent or “one” side of the relation and an infinity symbol designates the child or “many” side of the relation. In other words, a row in the parent table specifies zero or more rows in the child table. As shown, the Descriptor table 72 is a parent of the Version table 80, which is a parent of the Value table 78. The Property table 76 is also a parent of the Value table 78. The Type table 74 is a parent of the Descriptor table 72 and the Property table 76. The Version table 80 is a parent of itself and has a Version Version relation which couples the ParentVid to the Vid.

The data model also includes a Content table 82 having a relation to the Version table 80. The Content table 82 includes a Cid column and a Data column, and is related as a parent to the Version table 80. The Version table 80 also includes a Cid column. There is a one-to-one relation between the Cid that is the primary key of the Content Table 82 and the Cid column in the Version table 80. The Data column of the content table 82 is the place where the actual data is stored. The content for the object might be stored in different forms in different locations or require data compression or encryption. An attribute of the actual data is that there exists a lossless mechanism for transferring the actual content from one node to another.

A Baseline table 84 includes a globally unique baseline identifier (“Bid”), and is a child of a Baseline Descriptor table 86. The Baseline table 84 also includes a ParentBid column. The ParentBid column stores a parent baseline identifier (“ParentBid”), which indicates the Bid of a baseline that is the immediate ancestor of a current baseline (if there is an ancestor). The Baseline table 84 is a parent of itself. The Baseline Descriptor table 86 is related as a child to the Version table 80, and includes rows specifying each of the object versions associated with a particular baseline (identified by a Bid).

An Action table 88 is related as a child to the Version table 80 and includes an Aid for each object version specified in the Version table 80. For each action, the Action table 88 specifies the data and time of the action (“DateTime”), the user that performed the action (“User”) and a description of the action (“Description”).

The following table describes each element in the schema of FIG. 4:

| Element | Description |
|---|---|
| Descriptor Table | Includes one row for each domain object in the repository. |
| Version Table | Includes one row for each version of a domain object in the |
| | repository |
| Type Table | Includes one row for each type of domain object in the |
| | repository. |
| Property Table | Includes one row for each property of a domain object type |
| Value Table | Includes the value associated with the property for a specific |
| | version of a domain object. |
| Content Table | Includes one row for each version in the repository |
| Baseline Table | Specifies each baseline associated with an object or group of |
| | objects. |
| BaselineDescriptor Table | Relates each object version to a baseline. |
| Action Table | Records each action performed on an object and/or on each of a |
| | group of objects. |
| Oid Column | The object identifier. Uniquely indicates a domain object. |
| Vid Column | The version identifier. The tuple (Oid, Vid) uniquely identifies |
| | a specific version of a domain object. Fully described in [1]. |
| Tid Column | The type identifier. Uniquely indicates a type of domain object. |
| | This is a UUID. |
| Pid | The property identifier. Uniquely indicates a property of a type |
| | of domain object. This is a UUID. |
| Name Column | The name of the domain object. |
| VersionNo Column | The version number of the domain object. The tuple (Name, |
| | VersionNo) is non-unique while tuple (Oid, Vid) is unique. |
| | This concept is described in [1]. |
| ParentVid Column | The Vid of the previous version or empty (null) if the row |
| | represents the initial version of the domain object. |
| TypeName Column | The name of the type. |
| PropertyName Column | The name of the property. |
| Value Column | Includes the value for a property for a specific version of a |
| | domain object. |
| Cid Column | The content identifier. |
| Data Column | The actual data content stored in an object |
| Bid Column | The baseline identifier. Uniquely identifies the baseline for a |
| | group of objects (e.g., objects identified in Descriptor Table) |
| ParentBid Column | The parent baseline identifier. Identifies the baseline that is the |
| | immediate ancestor of this baseline or empty (null) if this |
| | baseline has no ancestor. |
| Aid Column | The action identifier. Uniquely identifies the action. |
| DateTime Column | The data and time of the action |
| User Column | Identification of the user that performed the action. |
| Description Column | Description of the action |
| Descriptor_Version Relation | Specifies the versions of a domain object. |
| Type_Descriptor Relation | Specifies the domain objects that are of a type. |
| Type_Property Relation | Specifies the properties for a specific type. |
| Property_Value Relation | Specifies the values that are specified for a specific property. |
| Version_Value Relation | Specifies the values that are specified for a specific version of a |
| | domain object. |
| Version_Version Relation | Specifies the previous version of a version of a domain object. |
| Content_Version Relation | Specifies the content that is stored for a specific version of a |
| | domain object. |
| Baseline_BaselineDescriptor | Specifies the object versions in each baseline. |
| Relation | |
| Version_BaselineDescriptor | Specifies each version in a baseline. |
| Relation | |
| Version_Action Relation | Specifies the action that is specified for a specific version of a |
| | domain object. |

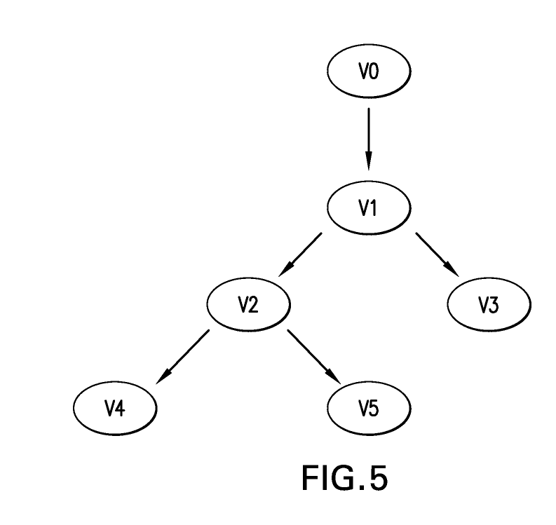

As discussed above, the ParentVid indicates the previous version of a particular version of an object. Because users can independently and potentially simultaneously access and edit data, the versions of an object may not necessarily follow a linear or chronological progression. For example, as shown in FIG. 5, if multiple users access and separately edit and save new versions of an object from the same previous version, the resulting set of versions forms a bifurcating tree of object versions.

The ParentVid, which associates each version with a parent version from which the version was created, allows this tree of object versions to be represented in a flat version table. For example, FIG. 5 illustrates that two users created separate versions (V2 and V3) from a previous version (V1), and two separate versions (V4 and V5) were created from the same previous version V2. Using the ParentVid, the relationships between versions can be represented in a version table as follows:

Version Table

| Oid | | Name | VersionNo | ParentVid |
|---|---|---|---|---|
| Column | Vid Column | Column | Column | Column |
| O1 | V0 | Object A | 1 | (Empty) |
| O1 | V1 | Object A | 2 | V0 |
| O1 | V2 | Object A | 3 | V1 |
| O1 | V3 | Object A | 3 | V1 |
| O1 | V4 | Object A | 4 | V2 |
| O1 | V5 | Object A | 4 | V2 |

The corresponding VidList (essentially a path from the root in this example) for each leaf of the tree can be represented as:
V3=(V0, V1, V3)
V4=(V0, V1, V2, V4)
V5=(V0V1, V2, V5)

The following example illustrates a potential configuration of metadata that incorporates the baseline and action features. In this example, various energy industry or oil and gas data collected from various operations and locations is stored in a data repository. Metadata associated with the stored data is also stored in the repository. Exemplary data includes well information, well log data, survey data and any other measurement data. Analysis data such as models may also be stored in the repository. In the following examples, the metadata is organized according to an EAV scheme as described above. However, the embodiments may be used with any suitable metadata organization schema, and is not limited to use with the specific types of metadata described herein. In addition, the embodiments described herein can be used with any type of data for which object-oriented programming is applicable.

For illustrative purposes, the repository is described as having two objects. A well object includes information regarding a specific well or borehole, such as location, depth, path description, well type (gas, oil, producer, exploration well, etc.) and state (e.g., open, active, closed, etc.). A log object includes logging data taken via, e.g., a wireline or logging-while-drilling (LWD) operation. The metadata for these objects includes the following tables:

Descriptor Table

| Oid Column | Tid Column |
|---|---|
| O1 | T1 |
| O2 | T2 |

Version Table

| Oid | Vid | Name | VersionNo | Parent- | Cid | Aid |
|---|---|---|---|---|---|---|
| Column | Column | Column | Column | VidColumn | Column | Column |
| O1 | V1 | BHJ- | 1 | (Empty) | | A1 |
| | | 10-1 | | | | |
| O2 | V2 | GR | 1 | (Empty) | C1 | A2 |
| O2 | V3 | GR | 2 | V2 | C2 | A3 |
| O2 | V4 | GR | 3 | V3 | C3 | A4 |

Type Table

| Tid Column | TypeName Column |
|---|---|
| T1 | Well Type |
| T2 | Log Type |

Property Table

| Pid Column | Tid Column | PropertyName Column |
|---|---|---|
| P1 | T1 | Well Location |
| P2 | T1 | Well Trajectory |
| P3 | T1 | Well State |
| P4 | T2 | Well |
| P5 | T2 | Log Kind |
| P6 | T2 | Log Header |

Value Table

| Oid | Vid | Pid | Value |
|---|---|---|---|
| O1 | V1 | P1 | (13942076, −35076495, −40.0) [Northing (ft), Easting (ft), Depth |
| | | | (ft)] |
| O1 | V1 | P2 | ((1247.42, 0.92175.4, 1345.3), (1.13, 201.92), . . . ) [MD (ft), Inc |
| | | | (deg), Azi (deg)] |
| O1 | V1 | P3 | (Type: Producer, Phase: Gas, Status: Open) |
| O2 | V2 | P4 | (O1, V1) |
| O2 | V2 | P5 | Gamma Ray |
| O2 | V2 | P6 | (25-Oct-2013 13:03:52, 1309.05-1343.66, 82-230, . . . ) [Sample |
| | | | date, depth range (ft), value range (gAPI), . . . ] |
| O2 | V3 | P4 | (O1, V1) |
| O2 | V3 | P5 | Gamma Ray |
| O2 | V3 | P6 | (25-Oct-2013 13:03:52, 1309.05-1343.66, 82-230, . . . ) [Sample |
| | | | date, depth range (ft), value range (gAPI), . . . ] |
| O2 | V4 | P4 | (O1, V1) |
| O2 | V4 | P5 | Gamma Ray |
| O2 | V4 | P6 | (25-Oct-2013 13:03:52, 1309.05-1343.66, 82-230, . . . ) [Sample |
| | | | date, depth range (ft), value range (gAPI), . . . ] |

Content Table

| Cid | Data |
|---|---|
| C1 | <data values> |
| C2 | <data values> |
| C3 | <data values> |

Baseline Table

| Bid Column | ParentBid Column |
|---|---|
| B1 | (Empty) |
| B2 | B1 |
| B3 | B2 |

Baseline Descriptor Table

| Baseline Identifier | Object Identifier | Version Identifier |
|---|---|---|
| B1 | O1 | V1 |
| B1 | O2 | V2 |
| B2 | O1 | V1 |
| B2 | O2 | V3 |
| B3 | O1 | V1 |
| B3 | O2 | V4 |

Action Table

| | | DateTime | |
|---|---|---|---|
| Aid Column | User Column | Column | Descriptor Column |
| A1 | Bob | 12/1/2013 | Created well from file import |
| | | 15:00 | |
| A2 | Bob | 12/1/2013 | Create log from file import |
| | | 15:10 | |
| A3 | Niels | 12/5/2013 | Edited Well Log |
| | | 09:00 | |
| A4 | Bob | 12/10/2013 | Edited Well Log |
| | | 17:00 | |

The Type table 74 thus includes two entries to indicate a well object and a log object, and two entries in the Descriptor table 72 (one the well and one for the log). There are corresponding entries in the Version table 80 for the well and the log. The Version table 80 indicates that one version (V1) of the well object (O1) has been stored, and three versions (V2, V3, V4) of the log object (O2) have been stored.

For both the well type and the log type, several properties (attributes) are defined. In this example, there are three property entries in the Property table 76 (location, trajectory and state) and three property entries for the log (well, log kind and log header). The Property table thus has six rows. The Value table 78 has twelve rows, three rows for each object version. The Content table 82 stores a Cid and associated content for each version of the log object, and is related to the version table via a copy of the Cid stored therein for each log object version.

The Action table 88 stores a chronological record of each action performed on the log object and the well object, including both creation and subsequent modification. In this example, a first user referred to as “Bob” created the well object and the log object on December 1. These actions are recorded as actions A1 and A2. The Action table 88 indicates the date and time of these actions, describe the actions and indicate that Bob was the user that performed them. On December 5, a second user referred to as “Niels” performed an action by making edits to the well log on December 5, and Bob made additional edits to the well log on December 10. These actions are recorded and identified as actions A3 and A4.

This record of all actions performed on this group of objects allows users to inspect the actions and determine whether any errors have been introduced, or otherwise determine which version of an object should be acted upon.

For example, Niels intends to edit the well log again at a later data. Niels notices that errors have been introduced into the well log, but cannot determine the source of the errors from mere inspection of the well log. By examining the audit trail stored in the Action table 88, Niels suspects that Bob's changes on December 10 (A4) are the source of the errors. As shown in the Version table 80, Bob's December 10 changes are stored as version V4, and the contents of version V4 are stored in the C3 row of the Content table 82.

In order to avoid the errors believed to be introduced by Bob, Niels can thus load baseline B2 which contains the previous well log version (O2, V3). Niels can create a new Baseline B4 which contains a reference to (O2, V3) and stored a new version (e.g., V5) of the well log that does not include Bob's December 10 edits. Baseline B3 and B4 are cousin baselines, each having as an immediate ancestor B2.

Bob's changes are still present in the repository and still tied to baseline B3. Bob and Niels might have a difference of opinion on the “errors” that Niels has found. Thus, Bob may continue to work with the well log version (O2, V4). The entire history of these changes on the well log by these users has been preserved along with the ability to revisit past actions and restore past versions of object states.

As demonstrated above, the audit trails created for an object or object group allow for inspection of the history of object modifications, which can be tracked back to the creation of the object. Moreover the object state can be examined in context with all related object states. An audit trail is connected to the object itself. Changes to objects can proceed along bifurcating paths and later be reconciled.

The embodiments described herein provide numerous advantages. Such advantages include the ability to track data modification histories and allow multiple users to implement competing changes while preserving previous changes. For example, in typical prior art systems, if Niels found errors in Bob's edits, he would simply have to throw away Bob's edits to continue. For Bob to continue with his change he would have to have special authorization to bifurcate the repository. Such a requirement is not part of the embodiments described herein; any user of the system can create branching changes which then become part of the audit trail for an object or other data structure.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A non-transitory computer-readable storage medium storing instructions which, when processed by a processor, cause the processor to implement a method of storing a data object and object provenance, the method comprising:
storing a globally unique object identifier that identifies the object, the object representing a data set;
storing a globally unique version identifier for each version of the object created by performing an action on the object, each version identifier stored in a version table associated with the object;
generating a globally unique action identifier in response to the action performed on the object, the action selected from at least one of creation of the object and modification of the object; and
storing an action table associated with the object and having a relation to the version table, the action table including a description of the action, the action table configured to store a record of all actions performed on the object and allow inspection of all actions.

2. The storage medium of claim 1, wherein the action table includes an action identifier for each action performed on the object, including initial creation of the object and an action associated with each version of the object.

3. The storage medium of claim 2, wherein the action table includes a user identifier associated with the action identifier that specifies which user of a plurality of users performed the action.

4. The storage medium of claim 1, wherein the object identifier and the version table are configured to be transmitted and stored as metadata independent of the data set while maintaining a relation to the data set.

5. The storage medium of claim 4, wherein the action table is transmitted and stored with the data set.

6. The storage medium of claim 1, wherein the action table is configured to provide a provenance of the object, and includes a list of all of the actions performed on the object since creation of the object.

7. The storage medium of claim 4, wherein the metadata includes a content table having a relation to the version table and configured to be transmitted and stored independent from the metadata, the content table storing the data set therein.

8. The storage medium of claim 1, wherein the method further comprises generating a globally unique baseline descriptor having a relation to the version table, the baseline descriptor associated with a baseline, the baseline identifying a state of each of a plurality of objects at a specific time.

9. The storage medium of claim 4, wherein the metadata is organized according to an entity-attribute-value (“EAV”) model, and further includes a descriptor table having the object identifier and a type identifier, a property table having the type identifier and a property identifier, and a value table related to the property table and the version table.

10. The storage medium of claim 1, wherein the data set includes data acquired in conjunction with an energy industry operation.

11. A method of storing a data object and object provenance, the method comprising:
storing a globally unique object identifier that identifies the object, the object representing a data set;
storing a globally unique version identifier for each version of the object created by performing an action on the object, each version identifier stored in a version table associated with the object;
generating a globally unique action identifier in response to the action performed on the object, the action selected from at least one of creation of the object and modification of the object; and
storing an action table associated with the object and having a relation to the version table, the action table including a description of the action, the action table configured to store a record of all actions performed on the object and allow inspection of all actions.

12. The method of claim 11, wherein the action table includes an action identifier for each action performed on the object, including initial creation of the object and an action associated with each version of the object.

13. The method of claim 12, wherein the action table includes a user identifier associated with the action identifier that specifies which user of a plurality of users performed the action.

14. The method of claim 11, wherein the object identifier and the version table are configured to be transmitted and stored as metadata independent of the data set while maintaining a relation to the data set.

15. The method of claim 14, wherein the action table is transmitted and stored with the data set.

16. The method of claim 11, wherein the action table is configured to provide a provenance of the object, and includes a list of all of the actions performed on the object since creation of the object.

17. The method of claim 14, wherein the metadata includes a content table having a relation to the version table and configured to be transmitted and stored independent from the metadata, the content table storing the data set therein.

18. The method of claim 11, further comprising generating a globally unique baseline descriptor having a relation to the version table, the baseline descriptor associated with a baseline, the baseline identifying a state of each of a plurality of objects at a specific time.

19. The method of claim 14, wherein the metadata is organized according to an entity-attribute-value (“EAV”) model, and further includes a descriptor table having the object identifier and a type identifier, a property table having the type identifier and a property identifier, and a value table related to the property table and the version table.

20. The method of claim 11, wherein the data set includes data acquired in conjunction with an energy industry operation.
